(19) United States
(12) Patent Application Publication
(10) Pub. No.: US 2007/0175287 A1
(43) Pub. Date: Aug. 2, 2007

(54) Power steering apparatus

(75) Inventor: Takayuki Tetsuka, Tochigi (JP)

Correspondence Address: Orum & Roth, LLC, Ste 1616, 53 W. Jackson Blvd., Chicago, IL, 60604, US

(73) Assignee: SHOWA CORPORATION

(21) Appl. No.: 11/521,288

(22) Filed: Sep. 14, 2006

(30) Foreign Application Priority Data
Jan. 27, 2006 (JP) 2006-019825

(51) Int. Cl. F16H 35/00

(52) U.S. Cl. 74/388 PS

(57) ABSTRACT

In a power steering apparatus using a mounting device attaching a steering gear housing to a vehicle body side while holding, the mounting device welds an inner surface of a slit provided in each of a plurality of positions in a peripheral direction of a holding portion of a bracket to the steering gear housing, welds a joint piece of the bracket to an outer periphery of a collar, and allows a bolt inserted to an inner periphery of the collar to be screwed to the vehicle body side.

### BACKGROUND OF THE INVENTION

1. Field of the Invention

The present invention relates to a power steering apparatus.

2. Description of the Related Art

In a power steering apparatus, there is a structure in which a rack shaft working with a steering input shaft is accommodated movably in a steering gear housing, and a mounting device mounting the steering gear housing to a vehicle body side while holding it is used, as described in Japanese Unexamined Patent Publication No. 2001-354150 (patent document 1).

The mounting device described in the patent document 1 is provided with an approximately C-shaped holding portion holding the steering gear housing, and a pair of mounting pieces extending to an outer side from both ends of the holding portion and facing to each other. The holding portion is closely attached to the steering gear housing while pinching a pair of mounting pieces with each other, and an entire periphery of an end surface of the holding portion is welded to the steering gear housing. A tubular spacer is inserted to a tube portion protruded in a direction moving close to each other from a pair of mounting pieces, and a bolt inserted to the spacer is screwed to the vehicle body side.

The patent document 1 mentioned above has the following problems.

(1) In a pair of mounting pieces of the mounting device, the tube portions for the bolt inserting spacer are protruded in the direction moving close to each other. Accordingly, the pinching margin of a pair of mounting pieces is limited to a gap range of the tube portions. It is difficult to closely attach the holding portion to the steering gear housing, and reliability of welding the holding portion to the steering gear housing is low.

(2) Since the mounting pieces are structured such as to weld the entire periphery in the end surface of the holding portion to the steering gear housing, a cross section of the steering gear housing tends to be adversely affected by welding heat strain.

(3) Since the mounting device is structured such as to weld the entire periphery in the end surface of the holding portion to the steering gear housing, it is necessary to rotate any one of a welding machine and a workpiece over an entire periphery around a center axis of the steering gear housing, so that welding workability is bad.

### SUMMARY OF THE INVENTION

An object of the present invention is to improve a welding property for welding a mounting device to a steering gear housing, in a structure for mounting a steering gear housing to a vehicle body side by a mounting device.

The present invention relates to a power steering apparatus structured such that a rack shaft working with a steering input shaft is movably accommodated into a steering gear housing, and a mounting device attaching the steering gear housing to a vehicle body side while at the same time holding. The mounting device is provided with an approximately C-shaped holding portion holding the steering gear housing. The device has a bracket provided with a pair of joint pieces extending to an outer side from both ends of the holding portion and facing to each other, and a collar inserted and attached to a hole provided in a joint piece of the bracket. The mounting device welds an inner surface of a slit provided in each of a plurality of positions in a peripheral direction of the holding portion of the bracket to the steering gear housing, welds the joint piece of the bracket to an outer periphery of the collar, and allows a bolt inserted to an inner periphery of the collar to be screwed to the vehicle body side.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is an entire cross sectional view showing a power steering apparatus;

FIG. 2 is a cross sectional view of a main portion in FIG. 1;

FIG. 3 is a cross sectional view along a line III-III in FIG. 2;

FIG. 4 is a view of a weld outer appearance of a mounting device;

FIG. 5 is a cross sectional view along a line V-V in FIG. 4; and

FIG. 6 is a view as seen from an arrow VI in FIG. 4.

### DESCRIPTION OF THE PREFERRED EMBODIMENTS

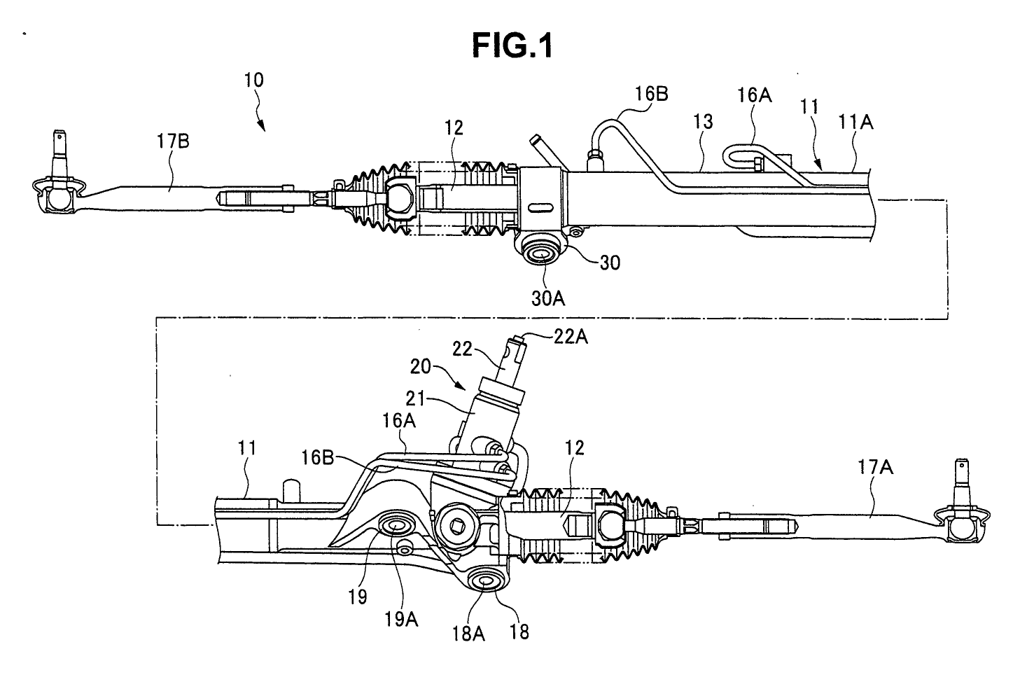

A hydraulic power steering apparatus 10 is structured, as shown in FIG. 1, such that a rack shaft 12 is accommodated in a rack shaft accommodating portion 11A of a steering gear housing 11 while supporting so as to be linearly movable. A power cylinder 13 is provided, a piston (not shown) is provided in the rack shaft 12 passing through the power cylinder 13, and a first chamber (not shown) and a second chamber 15B sectioned by a piston (not shown) are formed in an inner portion of the power cylinder 13. Further, in the hydraulic power steering apparatus 10, left and right tie rods 17A and 17B are coupled to the rack shaft 12, thereby assisting steering force of a steering wheel by a driver.

The hydraulic power steering apparatus 10 is structured such that a valve body 21 of a control valve 20 is fixed to the steering gear housing 11. The control valve 20 is structured such that an input shaft 22 rotating while working with the steering wheel is pivoted to the valve body 21. A circular rotor (not shown) integrally formed with the input shaft 22, and a circular sleeve (not shown) fixed to a leading end portion of a torsion bar 22A fixed to the input shaft 22 together with a pinion (not shown) are coaxially arranged so as to be relatively displaceable on the basis of an elastic torsional deformation of the torsion bar 22A in response to a steering torque applied to the steering wheel. A pump side supply flow path and a tank side return flow path are switched and connected to first and second supply and discharge flow paths 16A and 16B respectively connected to a first chamber (not shown) and a second chamber 15B of the power cylinder 13 in correspondence to a steering operation In this case, the pinion (not shown) fixed to the sleeve (not shown) is engaged with a rack gear of the rack shaft 12.

The hydraulic power steering apparatus 10 is provided with mounting portions 18 and 19 in one side along a longitudinal direction of a rack shaft accommodating portion 11A of the steering gear housing 11, and is provided with a mounting device 30 in the other side The hydraulic power steering apparatus 10 is structured such that the mounting portions 18 and 19 are integrally formed at a time of casting the steering gear housing 11. Bolts inserted to mounting holes 18A and 19A thereof are screwed with support portions (thread holes) of a vehicle body frame. The steering gear housing 11 is held by the mounting device 30, and a bolt inserted to a mounting hole 30A thereof is screwed with a support portion (a thread hole) of the vehicle body frame. Accordingly, the steering gear housing 11 is fixedly mounted to a predetermined mounted position to the vehicle body frame. A description will be given below of the mounting device 30.

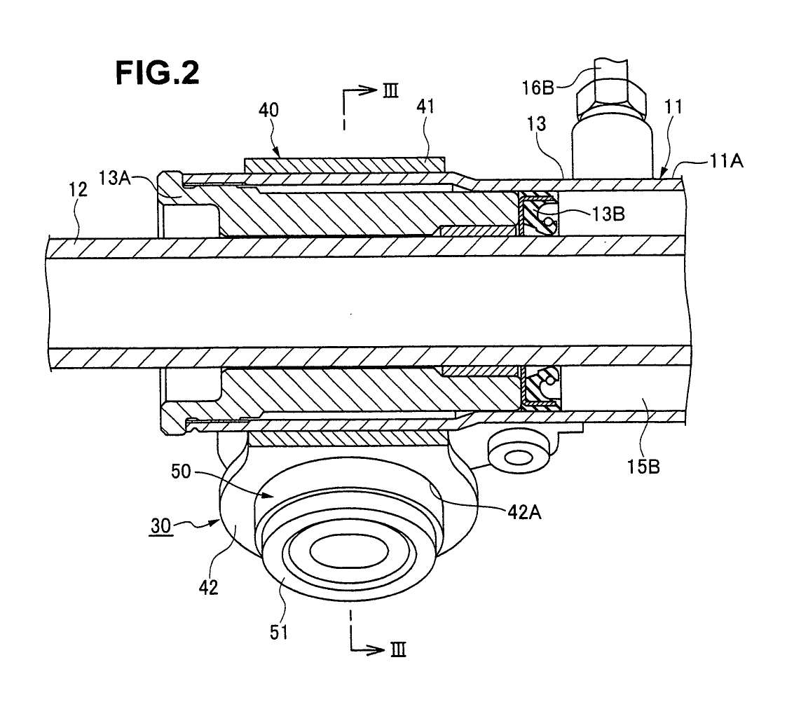

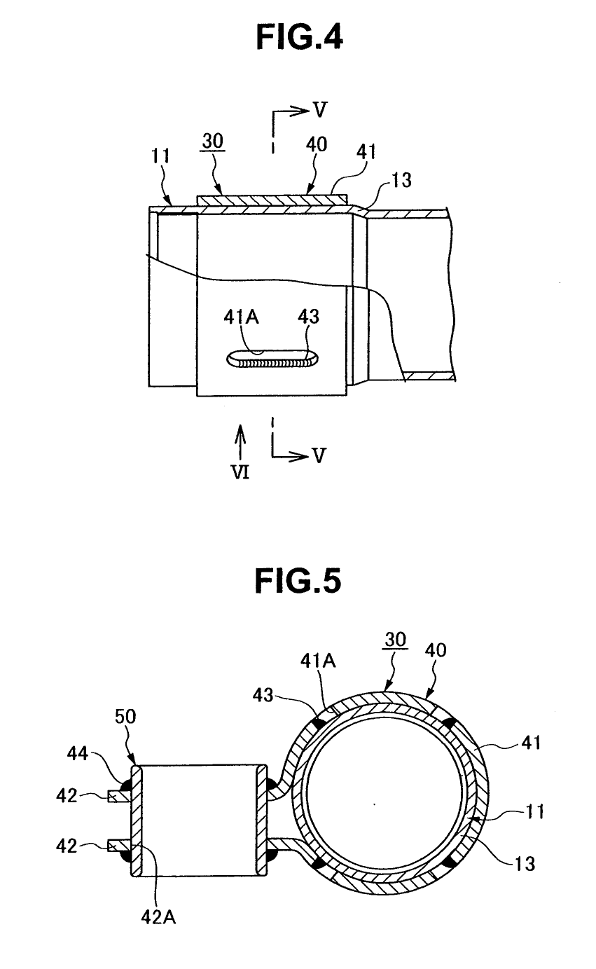

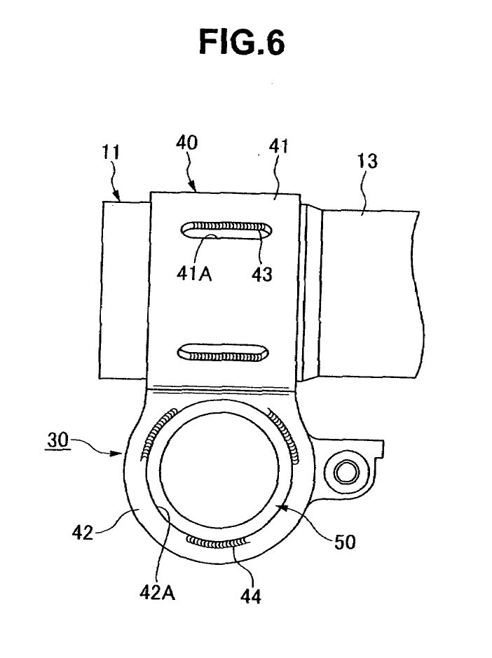

The mounting device 30 has a bracket 40 and a collar 50 as shown in FIGS. 2 to 6. The bracket 40 is provided with an approximately C-shaped holding portion 41 holding the power cylinder 13 of the steering gear housing 11, and is provided with a pair of joint pieces 42 extending to an outer side from both ends of the C-shape in the holding portion 41 and facing to each other in such a manner as to be in parallel to each other. The bracket 40 can be formed in accordance with a press molding of a sheet material having a fixed width. The collar 50 is constituted by a pipe member, and is inserted and attached to holes 42A provided in a pair of joint pieces 42 of the bracket 40.

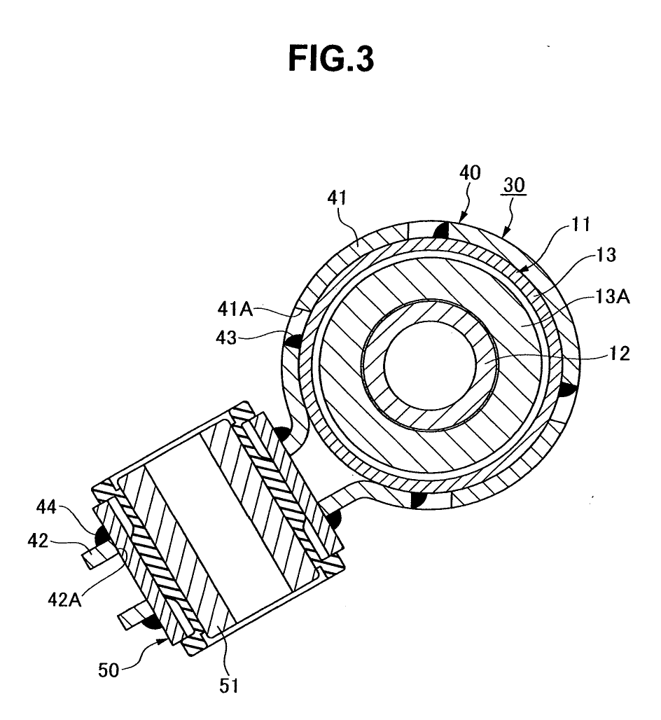

The mounting device 30 welds an inner surface of a slit 41A extended in the width direction of the holding portion 41 to an outer periphery of the power cylinder 13 in accordance with a laser beam welding (or an arc welding) (a weld portion 43) in each of a plurality of (four in the present embodiment) positions in a peripheral direction of the holding portion 41. In this manner, the holding portion 41 of the bracket 40 is held and attached to the power cylinder 13 of the steering gear housing 11. The mounting device 30 welds an outward surface of each of the Joint pieces 42 (an upward surface of the upper joint piece 42) and a downward surface of the lower joint piece 42 when viewing the steering gear housing 11 in a vertically arranged state shown in FIGS. 3 and 5 to an outer periphery of the collar 50 in accordance with a laser beam welding (or an arc welding (a weld portion 44), such that the collar 50 is inserted and attached to each of the holes 42A of a pair of joint pieces 42 of the bracket 40. The weld portion 44 is provided at a plurality of positions in a peripheral direction along an outer periphery (or in an entire periphery) of the collar 50.

The mounting device 30 is structured, as shown in FIGS. 2 and 3, such that a mount bush 51 is fitted and attached to an inner periphery of the collar 50, and an inner diameter of the mount bush 51 is formed as the mounting hole 30A mentioned above. In this case, in FIG. 2, reference symbol 13A denotes a cylinder end provided in one end of the power cylinder 13, and reference symbol 13B denotes an oil seal. The bracket 40 of the mounting device 30 holds an outer diameter portion in a portion to which the rack shaft guide 13A is inserted in the power cylinder 13.

A description will be given below of a procedure for installing the mounting device 30 in the steering gear housing 11.

(1) The holding portion 41 of the bracket 40 of the mounting device 30 is held and attached to the power cylinder 13 of the steering gear housing 11.

(2) A pair of joint pieces 42 of the bracket 40 are pinched by being pressurized from both sides, and the holding portion 41 is closely attached to the power cylinder 13 with no gap. In this state, the inner surfaces of two slits 41A in an upper half peripheral side of the holding portion 41 are welded to the power cylinder 13 in the weld portion 43. Subsequently, the upper side joint piece 42 is welded to the outer periphery of the collar 50 in the weld portion 44.

(3) In a state in which the steering gear housing 11 is inverted or as it is without being inverted, a pair of joint pieces 42 of the bracket 40 are again pinched by being pressurized from both sides, and the holding portion 41 is closely attached to the power cylinder 13 with no gap. In this state, the inner surfaces of two slits 41A in the lower half peripheral side of the holding portion 41 are welded to the power cylinder 13 in the weld portion 43. Subsequently, the upper side joint piece 42 is welded to the outer periphery of the collar 50 in the weld portion 44.

In the case that the steering gear housing 11 is inverted at a time of the item (3) mentioned above, it is possible to weld the lower half peripheral side of the holding portion 41 and the lower side joint piece 42 in accordance with a downhand welding. In the case that the steering gear housing 11 is not inverted, the lower half peripheral side of the holding portion 41 and the lower joint piece 42 are welded in accordance with an overhand welding.

In accordance with the present embodiment, the following operations and effects can be achieved.

(a) The mounting device 30 is provided with the hold 42A for the bolt inserting collar 50 in a pair of joint pieces 42 of the bracket 40. The joint pieces 42 simply slide on the outer periphery of the collar 50 while pinching a pair of joint pieces 42 for closely attaching the holding portion 41 to the steering gear housing 11. Accordingly, the pinching margin of a pair of joint pieces 42 is not limited by the existence of the wide interval between the joint pieces 42, but is sufficient for securely closely attaching the holding portion 41 to the steering gear housing 11. It is thereby possible to improve reliability of the welding of the holding portion 41 to the steering gear housing 11.

(b) The mounting device 30 is structured such as to weld the inner surface provided in each of a plurality of positions in the peripheral direction of the holding portion 41 of the bracket 40 to the steering gear housing 11, and does not weld the entire periphery of the holding portion 41 to the steering gear housing 11. Accordingly, the cross section of the steering gear housing 11 is not adversely affected by the welding heat strain. In the case that the steering gear housing 11 has the power cylinder 13, and the mounting device 30 holds the power cylinder 13, the heat strain of the power cylinder 13 does not deteriorate a sliding property of the piston.

(c) Since the mounting device 30 is not structured such as to weld the entire periphery of the holding portion 41 of the bracket 40 to the steering gear housing 11, it is possible to improve welding workability by the welding machine.

(d) In the case that the steering gear housing 11 has the power cylinder 13, and the mounting device 30 is structured such as to hold the power cylinder 13 so as to attach it to the vehicle body side, it is possible to achieve the items (a) to (c) mentioned above.

(e) It is possible to improve welding workability by the welding machine, by dividing the step by which the mounting device 30 welds the holding portion 41 of the bracket 40 to the steering gear housing 11 into the welding step of the upper half peripheral side of the holding portion 41, and the welding step of the lower half peripheral side.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A power steering apparatus structured such that a rack shaft working with a steering input shaft is movably accommodated in to a steering gear housing, and having a mounting device attaching the steering gear housing to a vehicle body side while holding,
the mounting device is provided with an approximately C-shaped holding portion holding the steering gear housing, and has a bracket provided with a pair of joint pieces extending to an outer side from both ends of the holding portion and facing to each other, and a collar inserted and attached to a hole provided in a joint piece of the bracket,
wherein the mounting device welds an inner surface of a slit provided in each of a plurality of positions in a peripheral direction of the holding portion of the bracket to the steering gear housing, welds the joint piece of the bracket to an outer periphery of the collar, and allows a bolt inserted to an inner periphery of the collar to be screwed to the vehicle body side.

2. A power steering apparatus as claimed in claim 1, wherein the steering gear housing has a power cylinder, and the mounting device is structured such as to attach the power cylinder to the vehicle body side while holding.

3. A power steering apparatus as claimed in claim 1, wherein the bracket is formed by press molding a sheet material having a fixed width, and the collar comprises a pipe material.

4. A power steering apparatus as claimed in claim 2, wherein the bracket is formed of press molded sheet material having a fixed width, and the collar comprises a pipe material.

5. A power steering apparatus as claimed in claim 2, wherein an inner surface of the slit is laser beam welded to an outer periphery of the power cylinder of the steering gear housing.

6. A power steering apparatus as claimed in claim 2, wherein an inner surface of the slit is arc welded to an outer periphery of the power cylinder of the steering gear housing.

7. A power steering apparatus as claimed in claim 2, wherein the bracket of the mounting device holds an outer diameter portion of a portion to which a rack shaft guide in the power cylinder is inserted.

8. A manufacturing method of a power steering apparatus provided with the mounting device as claimed in claim 1 in a steering gear housing, comprising the steps of
holding and attaching a holding portion of a bracket of the mounting device to a steering gear housing, closely attaching the holding portion to the steering gear housing while pinching a pair of joint pieces of the bracket with each other, welding an inner surface of a slit in an upper half peripheral side of the holding portion to the steering gear housing, welding an upper side joint piece to an outer periphery of the collar; and
again holding and attaching the holding portion of the bracket of the mounting device to the steering gear housing, closely attaching the holding portion to the steering gear housing while pinching a pair of joint pieces of the bracket with each other, welding the inner surface of the slit in a lower half peripheral side of the holding portion to the steering gear housing, and welding a lower side joint piece to the outer periphery of the collar.

9. A manufacturing method of a power steering apparatus provided with the mounting device as claimed in claim 2 in a steering gear housing, comprising the steps of.
holding and attaching a holding portion of a bracket of the mounting device to a steering gear housing, closely attaching the holding portion to the steering gear housing while pinching a pair of joint pieces of the bracket with each other, welding an inner surface of a slit in an upper half peripheral side of the holding portion to the steering gear housing, welding an upper side joint piece to an outer periphery of the collar; and
again holding and attaching the holding portion of the bracket of the mounting device to the steering gear housing, closely attaching the holding portion to the steering gear housing while pinching a pair of joint pieces of the bracket with each other, welding the inner surface of the slit in a lower half peripheral side of the holding portion to the steering gear housing, and welding a lower side joint piece to the outer periphery of the collar.

10. A manufacturing method of a power steering apparatus provided with the mounting device as claimed in claim 3 in a steering gear housing, comprising the steps of
holding and attaching a holding portion of a bracket of the mounting device to a steering gear housing, closely attaching the holding portion to the steering gear housing while pinching a pair of joint pieces of the bracket with each other, welding an inner surface of a slit in an upper half peripheral side of the holding portion to the steering gear housing, welding an upper side joint piece to an outer periphery of the collar; and
again holding and attaching the holding portion of the bracket of the mounting device to the steering gear housing, closely attaching the holding portion to the steering gear housing while pinching a pair of joint pieces of the bracket with each other, welding the inner surface of the slit in a lower half peripheral side of the holding portion to the steering gear housing, and welding a lower side joint piece to the outer periphery of the collar.

11. A manufacturing method of a power steering apparatus provided with the mounting device as claimed in claim 4 in a steering gear housing, comprising the steps of
holding and attaching a holding portion of a bracket of the mounting device to a steering gear housing, closely attaching the holding portion to the steering gear housing while pinching a pair of joint pieces of the bracket with each other, welding an inner surface of a slit in an upper half peripheral side of the holding portion to the steering gear housing, welding an upper side joint piece to an outer periphery of the collar; and
again holding and attaching the holding portion of the bracket of the mounting device to the steering gear housing, closely attaching the holding portion to the steering gear housing while pinching a pair of joint pieces of the bracket with each other, welding the inner surface of the slit in a lower half peripheral side of the holding portion to the steering gear housing, and welding a lower side joint piece to the outer periphery of the collar.

12. A manufacturing method of a power steeling apparatus provided with the mounting device as claimed in claim 5 in a steering gear housing, comprising the steps of
holding and attaching a holding portion of a bracket of the mounting device to a steeling gear housing, closely attaching the holding portion to the steering gear housing while pinching a pair of joint pieces of the bracket with each other, welding an inner surface of a slit in an upper half peripheral side of the holding portion to the steering gear housing, welding an upper side joint piece to an outer periphery of the collar; and
again holding and attaching the holding portion of the bracket of the mounting device to the steering gear housing, closely attaching the holding portion to the steering gear housing while pinching a pair of joint pieces of the bracket with each other, welding the inner surface of the slit in a lower half peripheral side of the holding portion to the steering gear housing, and welding a lower side joint piece to the outer periphery of the collar.

13. A manufacturing method of a power steering apparatus provided with the mounting device as claimed in claim 6 in a steering gear housing, comprising the steps of
holding and attaching a holding portion of a bracket of the mounting device to a steering gear housing, closely attaching the holding portion to the steering gear housing while pinching a pair of joint pieces of the bracket with each other, welding an inner surface of a slit in an upper half peripheral side of the holding portion to the steering gear housing, welding an upper side joint piece to an outer periphery of the collar; and
again holding and attaching the holding portion of the bracket of the mounting device to the steering gear housing, closely attaching the holding portion to the steering gear housing while pinching a pair of joint pieces of the bracket with each other, welding the inner surface of the slit in a lower half peripheral side of the holding portion to the steering gear housing, and welding a lower side joint piece to the outer periphery of the collar.

14. A manufacturing method of a power steering apparatus provided with the mounting device as claimed in claim 7 in a steering gear housing, comprising the steps of
holding and attaching a holding portion of a bracket of the mounting device to a steering gear housing, closely attaching the holding portion to the steering gear housing while pinching a pair of joint pieces of the bracket with each other, welding an inner surface of a slit in an upper half peripheral side of the holding portion to the steering gear housing, welding an upper side joint piece to an outer periphery of the collar; and
again holding and attaching the holding portion of the bracket of the mounting device to the steering gear housing, closely attaching the holding portion to the steering gear housing while pinching a pair of joint pieces of the bracket with each other, welding the inner surface of the slit in a lower half peripheral side of the holding portion to the steering gear housing, and welding a lower side joint piece to the outer periphery of the collar.
